(19) United States
(12) Patent Application Publication
(10) Pub. No.: US 2015/0114544 A1
(43) Pub. Date: Apr. 30, 2015

(54) MOUNTING STRUCTURE AND METHOD OF ATTACHING MOUNTING STRUCTURE TO SURFACE

(71) Applicant: CATERPILLAR INC., PEORIA, IL (US)

(72) Inventor: Aaron K. Amstutz, PEORIA, IL (US)

(73) Assignee: CATERPILLAR INC., PEORIA, IL (US)

(21) Appl. No.: 14/068,584

(22) Filed: Oct. 31, 2013

(51) Int. Cl. F16B 47/00; F16B 11/00; F16M 13/02; B32B 37/12

(52) U.S. Cl. CPC F16B 47/003; B32B 37/1292; F16B 11/006; F16M 13/02
USPC 156/66; 248/205.3

(57) ABSTRACT

A mounting structure for adhesively bonding onto a surface includes a base, an outer face of the base and an inner face of the base. An adhesive injection port is provided on the outer face of the base for supplying an adhesive. A primary adhesive flow path is provided on the inner face of the base. The primary adhesive flow path is in fluid communication with the adhesive injection port and allows the adhesive to flow. Further, a plurality of secondary adhesive flow paths originating from the primary adhesive flow path allow the adhesive to distribute on the inner face.

### TECHNICAL FIELD

The present disclosure relates to a mounting structure for adhesively bonding onto a surface and a method of securing the mounting structure onto the surface using adhesive bonding.

### BACKGROUND

In many industrial applications, it is necessary or desirable to mount or attach a component such as an electric harness, a hydraulic harness, small hardware, a display, a side view mirror or the like onto a supporting structure by means of an adhesive connection or a bond. For example, it may be necessary to attach hardware or the like to the supporting structure such as roll over protection structure (ROPS) in a machine. In a conventional system, the hardware is attached to the structure using welding technique. However, in case of a ROPS environment, welding is strictly prohibited.

Considering the stringent requirements, there has been an increasing demand for adhesive based mounting structures. These mounting structures utilize an adhesive flow channel for an adhesive to follow a guided path and thus spread across the surface of the mounting structure for bonding of mounting structure with the surface of the supporting structure. However, existing adhesive mounting structures have certain deficiencies such as reduced optimum bonding strength and excessive usage of adhesive.

German patent application DE10142944 discloses an adhesive based fastening system for attaching a device to a car dashboard or a windscreen. The device is positioned on the surface of the car where the attachment is required and a couple of fasteners are used for fastening the device. Further, the fastener includes a sealing ring, a cup shaped body with an outer flange and a vent on the outer surface. The sealing ring is stuck to the car surface. The cup shaped body includes a bore on its surface which is used for filling the adhesive. A partition is provided between the bore and vent to ensure the complete filling of the adhesive space.

### SUMMARY

In one aspect, the present disclosure provides a mounting structure for adhesively bonding onto a surface. The mounting structure includes a base, an outer face of the base and an inner face of the base. An adhesive injection port is provided on the outer face of the base for supplying an adhesive. A primary adhesive flow path is provided on the inner face of the base. The primary adhesive flow path is in fluid communication with the adhesive injection port and allows the adhesive to flow. Further, a plurality of secondary adhesive flow paths originating from the primary adhesive flow path allow the adhesive to distribute on the inner face.

In another aspect, the present disclosure provides a method of adhesively bonding the mounting structure onto the surface. The method includes placing the mounting structure onto the surface with the inner face of the mounting structure abutting the surface and supplying an adhesive through the adhesive injection port provided on the outer face of the mounting structure. Further, allowing the adhesive to flow through the primary adhesive flow path provided on the inner face and allowing the adhesive to distribute on the inner face using the plurality of secondary adhesive flow paths originating from the primary adhesive flow path.

Other features and aspects of this disclosure will be apparent from the following description and the accompanying drawings.

### BRIEF DESCRIPTION OF THE DRAWINGS

FIG. 1 illustrates a mounting structure attached to a surface, according to an embodiment of the present disclosure;

FIG. 2 illustrates a first perspective view of the mounting structure of FIG. 1;

FIG. 3 illustrates a top view of the mounting structure of FIG. 2;

FIG. 4 illustrates a second perspective view of the mounting structure of FIG. 2;

FIG. 5 illustrates a bottom view of the mounting structure of FIG. 2;

FIG. 6 illustrates a sectional view of the mounting member along a line XX′ shown in FIG. 5

FIG. 7 illustrates a top view of the mounting structure, according to another embodiment of the present disclosure;

FIG. 8 illustrates a bottom view of the mounting structure of FIG. 7; and

FIG. 9 illustrates a cross sectional view of the mounting structure of FIG. 2 adhesively bounded onto the surface.

### DETAILED DESCRIPTION

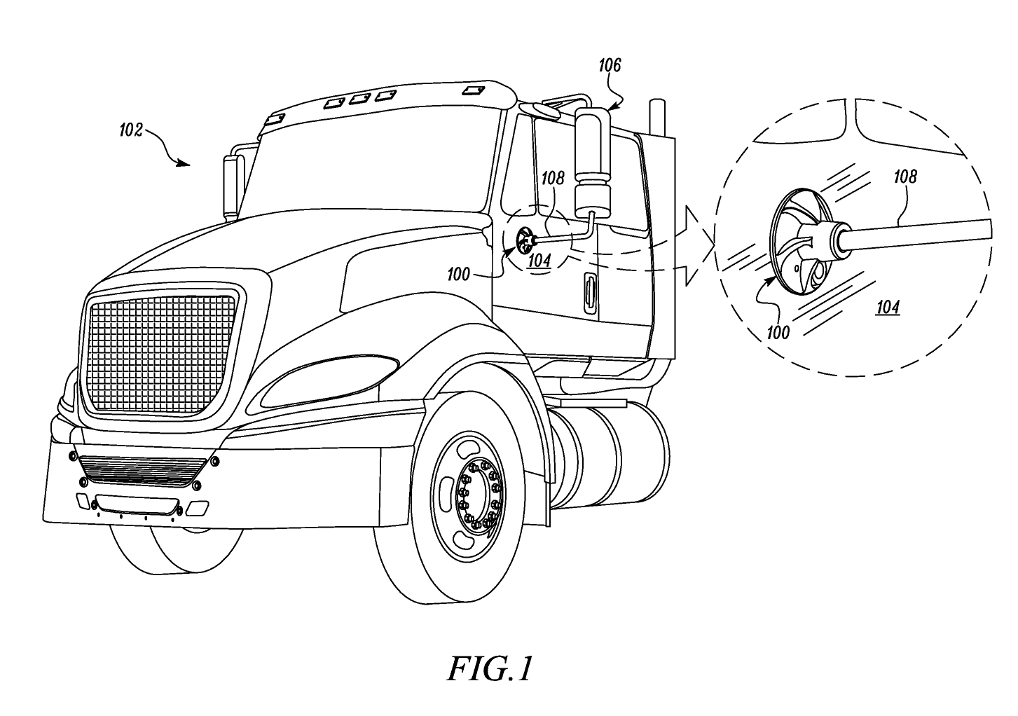

The present disclosure relates to a mounting structure for adhesively bonding onto a surface and a method of adhesively bonding the mounting structure onto the surface. FIG. 1 illustrates an exemplary mounting structure 100 attached to a machine 102, according to an embodiment of the present disclosure. The machine 102 is embodied as a truck, however in various other embodiments, the machine 102 may be any other type of mobile or stationary machines having application in earthmoving, mining or construction industry. In the illustrated embodiment, the mounting structure 100 is attached to a door surface 104 (hereinafter referred to as the surface 104) of the machine 102 and supports a component 106, such as a side view mirror. The surface 104 may be any surface and contemplated to include, but not limited to, an exterior and/or an interior surface associated with the machine 102 and/or any sub-system of the machine 102.

The component 106 may be supported on the mounting structure 100 via an attachment hardware 108 associated with the component 106. The attachment hardware 108 may be secured with the mounting structure 100 at one end and support the component 106 at other end. Alternatively, the component 106 may be directly secured to the mounting structure 100. In various other embodiments, the component 106 may be any component required to be attached onto the surface 104 along with or without the attachment hardware 108 for example, but not limited to, an electric or hydraulic harnesses, a display mount, fire extinguisher supports, etc.

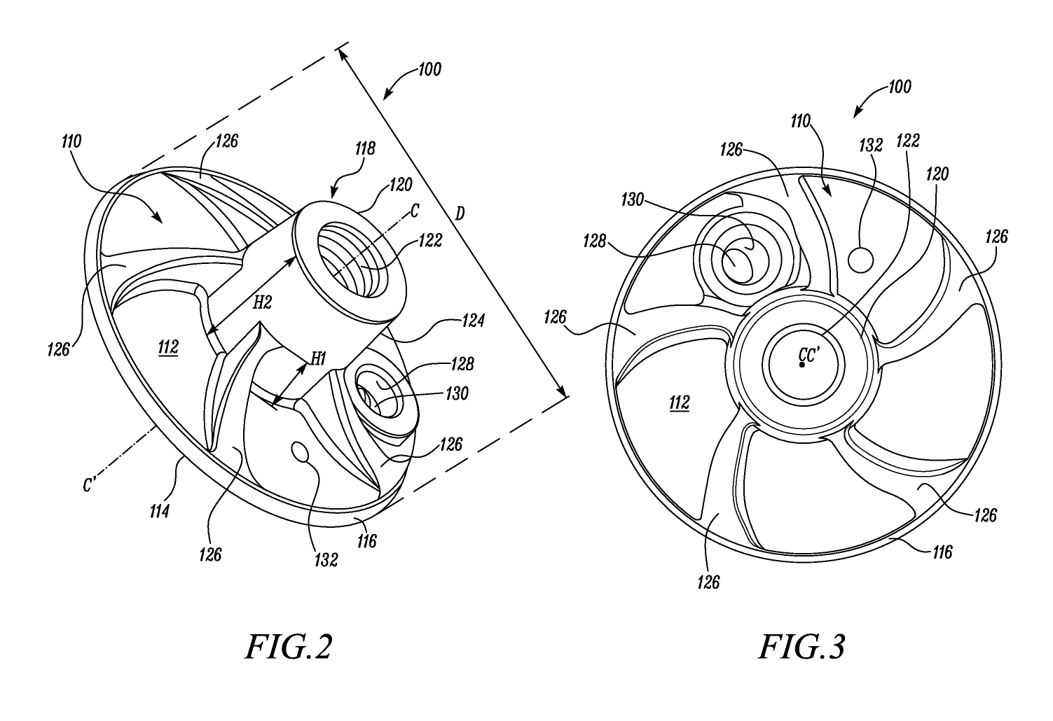

FIGS. 2 and 3 illustrate a first perspective view and a top view of the mounting structure 100 of FIG. 1, respectively. The mounting structure 100 includes a base 110 having an outer face 112 and an inner face 114. In an embodiment, the base 110 has a substantially circular disc-like shape bounded by an outer edge 116. The base 110 may have a diameter D, and a center axis CC′ passing through geometric center of the base 110. In an embodiment, the diameter D of the base 110 may lie in a range of about 30 mm to 100 mm. In various other alternative embodiments, the base 110 may have other type of geometrical shapes, for example, but not limited to, rectangular, square, oval or any other polygonal shape.

The mounting structure 100 further includes an attachment portion 118 provided on the outer face 112 of the base 110. The attachment portion 118 is configured to secure the attachment hardware 108 and/or the component 106 with the mounting structure 100. According to an embodiment, the attachment portion 118 may include a mounting boss 120 extending along the center axis CC′ from the outer face 112. The mounting boss 120 may have a substantially cylindrical shape with a threaded opening 122 at a distal end 124. The threaded opening 122 is configured to receive the attachment hardware 108, for example, an externally threaded shaft (see FIG. 1) associated with the component 106.

According to an embodiment, the mounting boss 120 and the base 110 may be formed as a single unitary body. In various other embodiments, the mounting boss 120 may include other types of geometric shapes, for example, but not limited to, rectangle, square, oval or any other polygonal shape.

Further, pluralities of ribs 126 are disposed around the mounting boss 120. The ribs 126 extend radially outward from the mounting boss 120 towards the outer edge 116 of the base 110. Further, the ribs 126 may extend arcuately outward and downward towards the outer edge 116. The ribs 126 are configured to resist a torque applied on the mounting boss 120 during an assembly process of the attachment hardware 108 and/or the component 106 on the mounting structure 100.

In an embodiment, the ribs 126 may include an array of uniformly contoured, oriented, and spaced arcuate ribs 126 attached to the mounting boss 120 and the outer face 112 In an embodiment, the ribs 126 are attached to the mounting boss 120 at a height H1 from the outer face 112 which is substantially half of an overall height H2 of the mounting boss 120. The difference in heights, H1 and H2, provide a clearance near the distal end 124 for receiving a coupling arrangement, such as hose clamp, when inserted on the mounting boss 120.

In various other embodiments, the attachment portion 118 may include any other structures, for example, but not limited to, one or more flanges extending from the outer face 112, a stud, a ring, a peg, or a hook. The various structures embodied as the attachment portion 118 provided on the outer face 112 of the base 110 are configured to secure the attachment hardware 108 and/or the component 106 directly. Further, the attachment portion 118 may be pivotally or fixedly attached to the outer face 112 of the base 110 depending upon the application and/or design characteristics of the component 106 required to be attached to the surface 104 via the mounting structure 100.

The mounting structure 100 further includes an adhesive injection port 128 formed on the base 110. The adhesive injection port 128 extends axially between the outer face 112 and the inner face 114. As illustrated in FIG. 3, the adhesive injection port 128 includes a flap portion 130 towards the inner face 114. An adhesive overflow port 132 is formed on the base 110 extending between the outer face 112 and the inner face 114. In an embodiment according to the present disclosure, the adhesive injection port 128 and the adhesive overflow port 132 may lie adjacent to each other and positioned at either side of the rib 126.

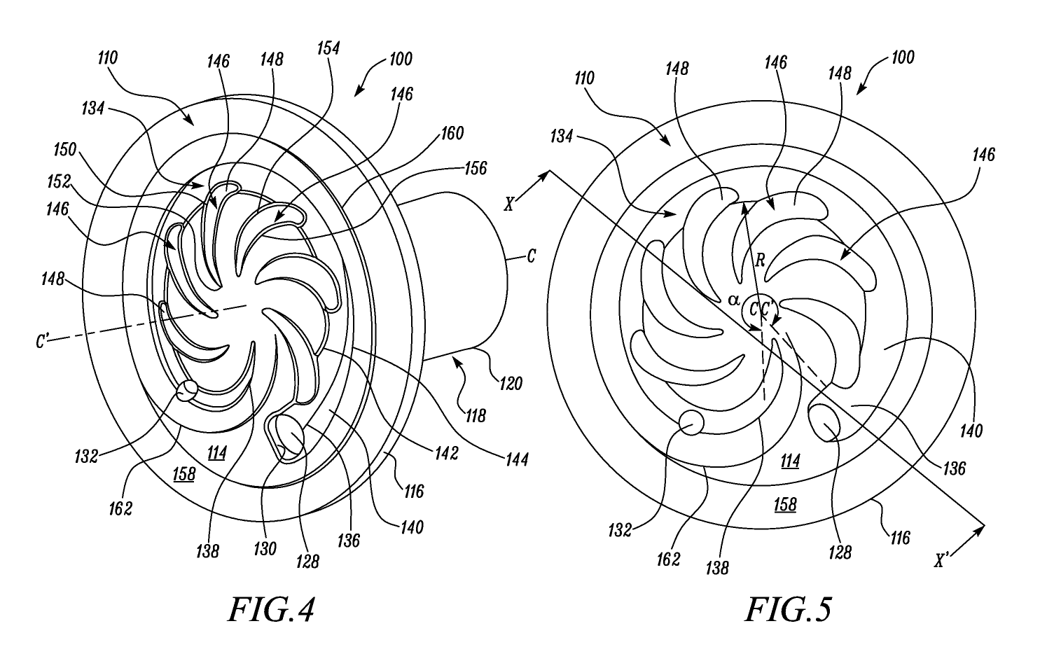

FIGS. 4 and 5 illustrate a second perspective view and a bottom view of the mounting structure 100, respectively, according to an embodiment of the present disclosure. The mounting structure 100 includes the substantially planar inner face 114 on which a primary adhesive flow path 134 is provided. The primary adhesive flow path 134 includes a first end 136 and a second end 138. The primary adhesive flow path 134 is in fluid communication with the adhesive injection port 128 at the first end 136. Further, the primary adhesive flow path 134 is in fluid communication with the adhesive overflow port 132 in proximity of the second end 138. The primary adhesive flow path 134 may include a first arcuate surface 140 formed as a groove extending between the first end 136 and the second end 138. Further, the first arcuate surface 140 defines a first edge 142 and a second edge 144 with the inner face 114, wherein the first and second edges 142, 144 may have a substantially curved profile extending between the first end 136 and the second end 138.

As illustrated in FIG. 5, the first arcuate surface 140 partially extends along a circular path, positioned between the center axis CC′ and the outer edge 116 of the base 110, at a substantially constant radial distance R from the center axis CC′ of the base 110. In the illustrated embodiment, the first arcuate surface 140 may further extend towards the center axis CC′ of the base 110 at the proximity of the second end 138. Moreover, the first end 136 and the second end 138 of the primary adhesive flow path 134 forms an angle α with the center axis CC′ of the base 110. In an embodiment of the present disclosure, the angle α may be 180 degrees or more. In another embodiment, the angle α may be between 240 and 315 degrees to substantially surround the center axis CC′ of the base 110.

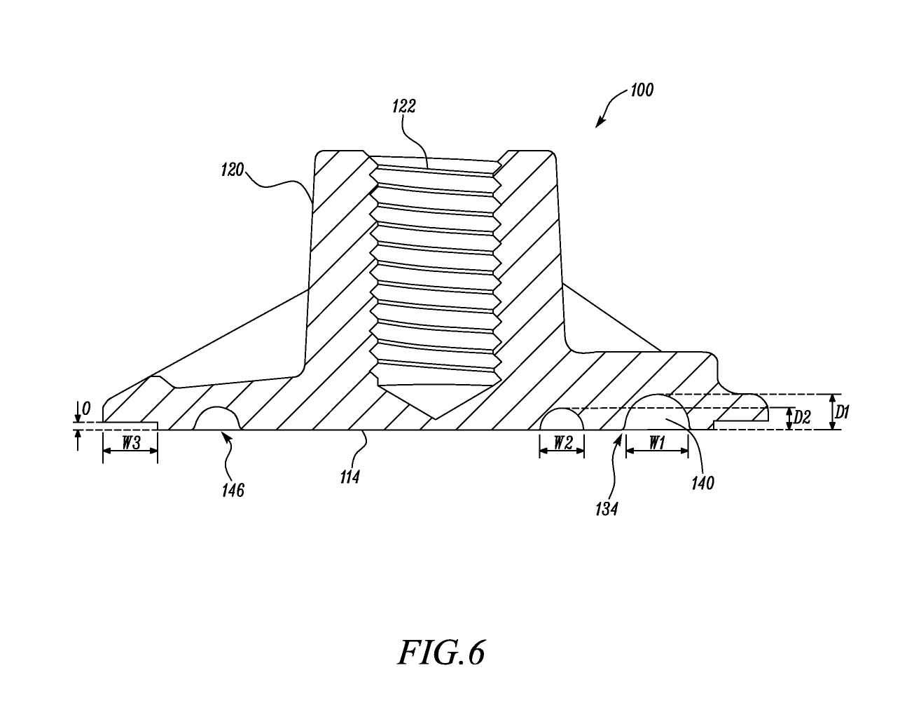

FIG. 6 illustrates a sectional view of the mounting structure 100 along a line XX′ shown in FIG. 5. As illustrated in FIG. 6, the first arcuate surface 140 forming the primary adhesive flow path 134 has a width and a depth continuously decreasing from a first width W1, and a first depth D1 at the adhesive injection port 128 to a second width W2, and a second depth D2 at the adhesive overflow port 132, respectively. In an embodiment, the first width W1 and the first depth D1 of the primary adhesive flow path 134 are substantially twice the second width W2 and the second depth D2 of the primary adhesive flow path 134, respectively.

Referring back to FIGS. 4 and 5, according to an embodiment of the present disclosure, a plurality of secondary adhesive flow paths 146 originate from the primary adhesive flow path 134 at multiple locations between the first end 136 and the second end 138. Each of the secondary adhesive flow path 146 may include a second arcuate surface 148 formed as groove on the inner face 114 of the base 110. The second arcuate surfaces 148 may extend arcuately, and radially inward from the first arcuate surface 140 towards the geometrical center of the base 110. The second arcuate surfaces 148 forming the secondary adhesive flow paths 146 may also have a width and depth that continuously decrease from joining edges 150 with the first edge 142 of the first arcuate surface 140 towards a tip portion 152 of each of the second arcuate surfaces 148. In an embodiment, the joining edges 150 may have a curved profile. Further, the second arcuate surface 148 also defines a first edge 154 and a second edge 156 with the inner face 114, wherein the first and second edges 154, 156 have a substantially curved profile extending between the joining edges 150 and the tip portion 152.

According to an embodiment of the present disclosure, the mounting structure 100 may include a perimetrical recessed surface 158 provided on the inner face 114. The perimetrical recessed surface 158 may be at an offset from a plane of the inner face 114 by a distance O and have a width W3 (see FIG. 6). The distance O is measured along a perimetrical ridge 160. In an embodiment, the distance O may lie in a range of about 0. 4 mm to 1. 0 mm and the width W3 of the perimetrical recessed surface 158 may lie in a range of about 4 mm to 10 mm. Further, the perimetrical ridge 160 entirely surrounds the primary adhesive flow path 134 and may include an upright wall having an inset radius. The perimetrical ridge 160 may further extend towards the geometrical center of the inner face 114 adjacent to the flap portion 130 and form an auxiliary ridge 162 between the adhesive injection port 128 and the adhesive overflow port 132.

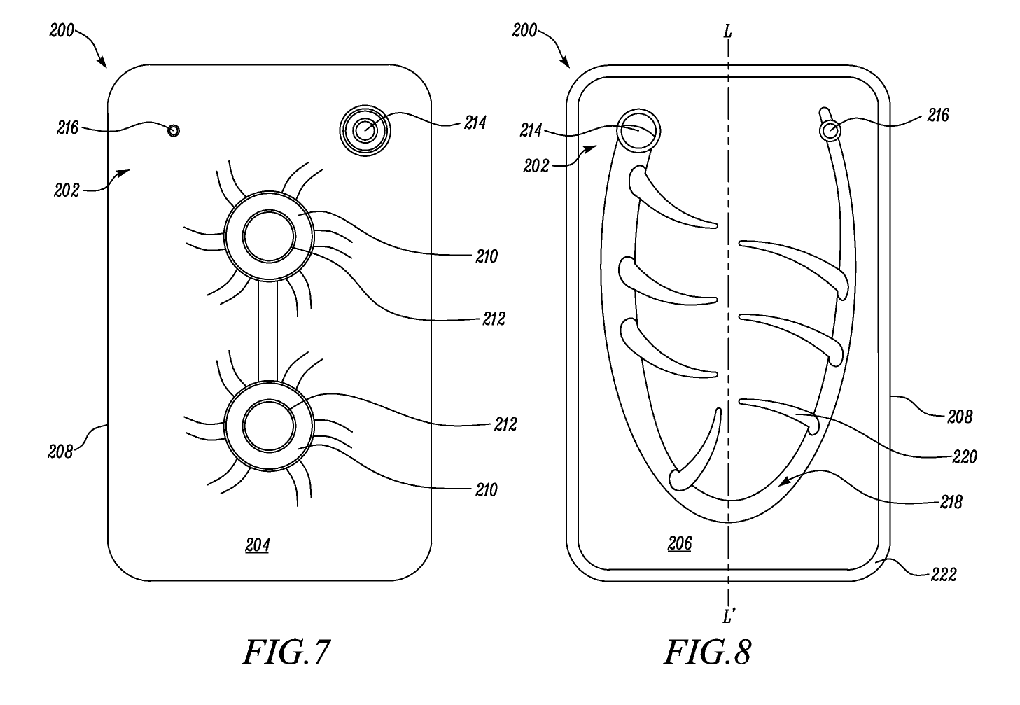

FIGS. 7 and 8 illustrate a top view and a rear view of a mounting structure 200, according to another embodiment of the present disclosure. The mounting structure 200 includes a base 202 with an outer face 204 and an inner face 206. In an embodiment, the base 202 has a substantially rectangular shape bounded by an outer edge 208. Further, the outer face 204 includes two mounting bosses 210. Each of the mounting bosses 210 extends from the outer face 204 of the base 202 and has a threaded opening 212. According to an embodiment of the present disclosure, the mounting structure 200 may have application while securing comparatively heavier components such as, fire extinguishers or displays onto a surface associated with ROPS and/or beam structure within a cab of the machine 100.

The mounting structure 200 may include an adhesive injection port 214 and an adhesive overflow port 216. As illustrated in FIG. 8, a primary adhesive flow path 218 is provided on the inner face 206 which is in fluid communication with the adhesive injection port 214 and the adhesive overflow port 216. Further, a plurality of secondary adhesive flow paths 220 are originating from the primary adhesive flow path 218 and oriented towards a center line LL′ of the mounting structure 200. The adhesive flow paths 218, 220 may have an arcuate profile substantially similar to the adhesive flow paths 134, 146. Moreover, a perimetrical recessed surface 222 entirely surrounding the adhesive flow path 218, 220 provided on the inner face 206. The perimetrical recessed surface 222 may be offset from a plane of the inner face 206.

It will be apparent to a person having ordinary skill in the art that the mounting structures 100 and 200 may have substantially similar constructional features and manufactured by known techniques such as die-casting or injection molding using metallic alloys or plastic composites. In an embodiment, the mounting structures 100, 200 may be manufactured from commercially available plastic composites such as, but not limited to glass reinforced polymers, Aluminum alloys, or Magnesium alloys.

### INDUSTRIAL APPLICABILITY

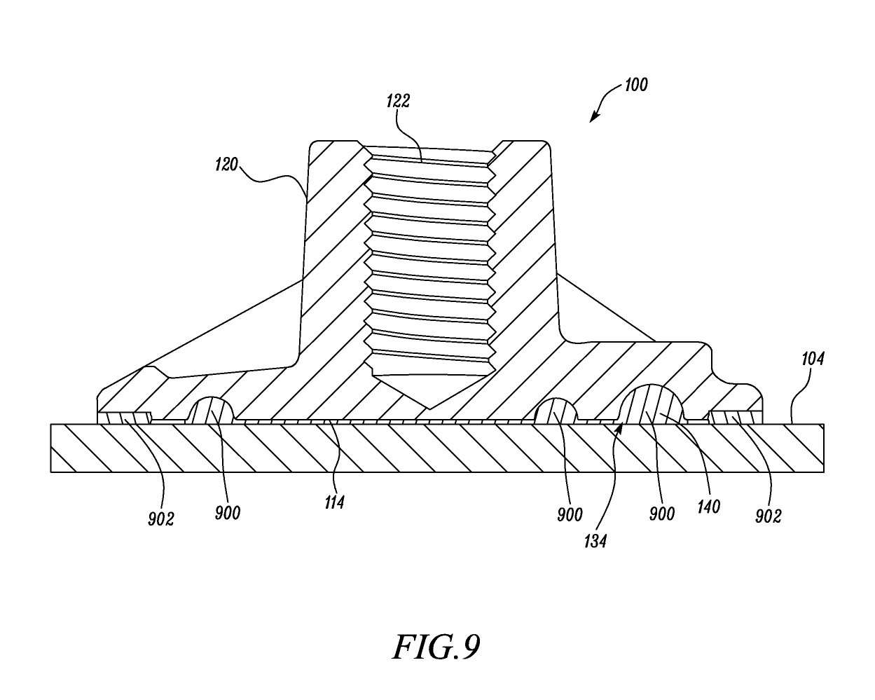

The industrial applicability of the exemplary mounting structures 100, 200 described herein will be readily appreciated from the foregoing discussion. FIG. 9 illustrates a cross sectional view of the mounting structure 100 of FIG. 2 adhesively bonded onto the surface 104, according to an aspect of the present disclosure. For adhesively bonding the mounting structure 100 onto the surface 104 using an adhesive 900, firstly, the mounting structure 100 is placed onto the surface 104 with the inner face 114 of the mounting structure 100 abutting the surface 104. As illustrated in FIG. 9, a double sided tape 902 is provided along the perimetrical recessed surface 158 of the mounting structure 100, such that while placing the mounting structure 100 onto the surface 104, a liner of the double sided tape 902 is removed to fix the mounting structure 100 at a desired location on the surface 104. Subsequently, the adhesive 900 is supplied through the adhesive injection port 128 provided on the outer face 112 of the mounting structure 100 using an adhesive gun (not shown). As the adhesive injection port 128 is in fluid communication with the primary adhesive flow path 134 provided on the inner face 114, this allows the adhesive 900 to flow through the primary adhesive flow path 134. The supply of the adhesive 900 is continued until the adhesive 900 extrudes through the adhesive overflow port 132.

The adhesive 900 is distributed on the inner face 114 using the secondary adhesive flow paths 146. The joining edge 150 having the curved profile allows a smooth flow of the adhesive 900 in the secondary adhesive flow paths 146. Further, the first and second edges 142, 144, 154, 156 of the first and second arcuate surfaces 140, 148 may allow a smooth flow of the adhesive 900 on the inner face 114. An undesired distribution of the adhesive 900 on the inner face 114 towards the outer edge 116 is limited by the double sided tape 902. Moreover, while supplying the adhesive 900 through the adhesive injection port 128 the adhesive 900 is diverted towards the primary adhesive flow path 134 using the flap portion 130 provided in the adhesive injection port 128. Finally, the adhesive 900 is allowed to cure and form a bonding between the inner face 114 and the surface 104.

As opposed to conventional method of welding and/or using bolts to attach a mounting structure onto a surface, adhesively bonding the mounting structures 100, 200 on the surface 104 provides more manufacturing flexibility and can a reduce manufacturing time and cost. During an exemplary manufacturing cycle a component may be attached to the mounting structure 100, 200 after a paint job and/or can be customized as per a customer's preferences. Moreover, adhesively bonding the mounting structures 100, 200 onto a surface of a component, such as a Roll Over Protection Structure (ROPS) where the application of welding or a bolted joint is limited or sometimes completely prohibited, provides an effective manufacturing alternative.

According to an aspect of the present disclosure, the first and the second arcuate surfaces 140, 148 of the adhesive flow paths 134, 146 provides an improved control over a quantity and a flow rate of the adhesive 900 while using the adhesive gun for supplying the adhesive 900. Further, the double side tape 902 provided along the perimetrical recessed surface 158 limits an outward overflow of the adhesive 900 and avoids requirements of subsequent cleaning and labor. Furthermore, according to the present disclosure, the adhesively bonding of the mounting structures 100, 200 with the adhesive flow paths 134, 146 provide a sufficient surface area for strengthening the attachment.

From the foregoing it will be appreciated that, although specific embodiments have been described herein for purposes of illustration, various modifications or variations may be made without deviating from the spirit or scope of inventive features claimed herein. Other embodiments will be apparent to those skilled in the art from consideration of the specification and figures and practice of the arrangements disclosed herein. It is intended that the specification and disclosed examples be considered as exemplary only, with a true inventive scope and spirit being indicated by the following claims and their equivalents.

What is claimed is:

1. A mounting structure for adhesively bonding onto a surface, the mounting structure comprising:
a base;
an outer face of the base;
an inner face of the base;
an adhesive injection port provided on the outer face;
a primary adhesive flow path provided on the inner face, the primary adhesive flow path is in fluid communication with the adhesive injection port; and
a plurality of secondary adhesive flow paths provided on the inner face, the plurality of secondary adhesive flow paths originating from the primary adhesive flow path.

2. The mounting structure of claim 1 further comprises an adhesive overflow port provided on the outer face, wherein the adhesive overflow port is in fluid communication with the primary adhesive flow path.

3. The mounting structure of claim 1, wherein the primary adhesive flow path having a first arcuate surface with a width and a depth continuously decreasing from a first width and a first depth at the adhesive injection port to a second width and a second depth at the adhesive overflow port.

4. The mounting structure of claim 3, wherein the secondary adhesive flow path having a second arcuate surface extending radially inward from the first arcuate surface towards a geometrical center of the base.

5. The mounting structure of claim 1 further comprises an attachment portion provided on the outer face, wherein the attachment portion is configured to secure a component with the mounting structure.

6. The mounting structure of claim 5, wherein the attachment portion includes a mounting boss.

7. The mounting structure of claim 6, wherein the mounting boss comprising a threaded hole at a distal end of the mounting boss.

8. The mounting structure of claim 5 further comprises a plurality of ribs disposed around the mounting boss.

9. The mounting structure of claim 1, wherein the adhesive injection port comprising a flap portion towards the inner face.

10. The mounting structure of claim 1 further comprises a perimetrical recessed surface provided on the inner face.

11. The mounting structure of claim 10, wherein the perimetrical recessed surface is at an offset from a plane of the inner face measured along a perimetrical ridge.

12. The mounting structure of claim 11, wherein the perimetrical ridge entirely surrounds the primary adhesive flow path.

13. The mounting structure of claim 1 has substantially circular disc-like shape bounded by an outer edge.

14. The mounting structure of claim 1 has a substantially rectangular shape bounded by an outer edge.

15. The mounting structure of claim 1 is manufactured by at least one of a die-casting and injection molding.

16. A method of adhesively bonding a mounting structure onto a surface, the method comprising:
placing the mounting structure onto the surface with an inner face of the mounting structure abutting the surface;
supplying an adhesive through an adhesive injection port provided on an outer face of the mounting structure;
allowing the adhesive to flow through a primary adhesive flow path provided on the inner face, wherein the primary adhesive flow path is in fluid communication with the adhesive injection port flow path; and
allowing the adhesive to distribute on the inner face using a plurality of secondary adhesive flow paths originating from the primary adhesive flow path.

17. The method of claim 16 further comprises allowing the adhesive to overflow through an adhesive overflow port in fluid communication with the primary adhesive flow path.

18. The method of claim 16 further comprises allowing the adhesive to cure between the inner face and the surface.

19. The method of claim 16, wherein placing the mounting structure onto the surface comprises fixing the mounting structure on the surface using an adhesive tape disposed between a perimetrical recessed surface provided on the inner face and the surface.

20. The method of claim 16, wherein supplying an adhesive through the adhesive injection port comprises diverting the adhesive towards the primary adhesive flow path using a flap portion provided in the adhesive injection port.
